(19) United States
(12) Patent Application Publication
(10) Pub. No.: US 2023/0124322 A1
(43) Pub. Date: Apr. 20, 2023

(54) SYSTEMS AND METHODS FOR MEASURING MOBILE INTERFERENCE IN OFDM DATA

(71) Applicant: ARRIS Enterprises LLC, Suwanee, GA (US)

(72) Inventors: David Emery VIRAG, Johns Creek, GA (US); Santhana CHARI, Johns Creek, GA (US)

(73) Assignee: ARRIS Enterprises LLC, Suwanee, GA (US)

(21) Appl. No.: 17/966,505

(22) Filed: Oct. 14, 2022

Related U.S. Application Data
(60) Provisional application No. 63/256,372, filed on Oct. 15, 2021.

(51) Int. Cl. H04B 17/345; H04W 24/10; H04W 24/02

(52) U.S. Cl. CPC H04B 17/345; H04W 24/02; H04W 24/10

(57) ABSTRACT

Systems and methods that receive noise measurements associated with a network device in a communications network, and for each of the plurality of subcarriers, and use the noise measurements to characterize the severity of noise ingress into the network device specifically due to interference from wireless communications in proximity to the network device.

### CROSS REFERENCE TO RELATED APPLICATIONS

The present application claims the benefit of U.S. Provisional Pat. Application No. 63/256,372 filed on Oct. 15, 2021, the contents of which are incorporated by reference herein.

### BACKGROUND

The subject matter of this application generally relates to systems and methods that measure the amount of wireless interference in a CATV hardline network. Cable Television (CATV) services have historically provided content to large groups of subscribers from a central delivery unit, called a “head end,” which distributes channels of content to its subscribers from this central unit through a branch network comprising a multitude of intermediate nodes. Historically, the head end would receive a plurality of independent programming content, multiplex that content together while simultaneously modulating it according to a Quadrature Amplitude Modulation (QAM) scheme that maps the content to individual frequencies or “channels” to which a receiver may tune so as to demodulate and display desired content.

Modem CATV service networks, however, not only provide media content such as television channels and music channels to a customer, but also provide a host of digital communication services such as Internet Service, Video-on-Demand, telephone service such as VoIP, and so forth. These digital communication services, in turn, require not only communication in a downstream direction from the head end, through the intermediate nodes and to a subscriber, but also require communication in an upstream direction from a subscriber, and to the content provider through the branch network.

To this end, these CATV head ends include a separate Cable Modem Termination System (CMTS), used to provide high speed data services, such as video, cable Internet, Voice over Internet Protocol, etc. to cable subscribers. Typically, a CMTS will include both Ethernet interfaces (or other more traditional high-speed data interfaces) as well as RF interfaces so that traffic coming from the Internet can be routed (or bridged) through the Ethernet interface, through the CMTS, and then onto the optical RF interfaces that are connected to the cable company’s hybrid fiber coax (HFC) system. Downstream traffic is delivered from the CMTS to a cable modem in a subscriber’s home, while upstream traffic is delivered from a cable modem in a subscriber’s home back to the CMTS. Many modern CATV systems have combined the functionality of the CMTS with the video delivery system (EdgeQAM) in a single platform called the Converged Cable Access Platform (CCAP). Still other modern CATV systems called Remote PHY (or R-PHY) relocate the physical layer (PHY) of a traditional CCAP by pushing it to the network’s fiber nodes. Thus, while the core in the CCAP performs the higher layer processing, the R-PHY device in the node converts the downstream data sent by the core from digital-to-analog to be transmitted on radio frequency as a QAM signal, and converts the upstream RF data sent by cable modems from analog-to-digital format to be transmitted optically to the core. Other modern systems push other elements and functions traditionally located in a head end into the network, such as MAC layer functionality(R-MACPHY), etc.

CATV systems traditionally bifurcate available bandwidth into upstream and downstream transmissions, i.e., data is only transmitted in one direction across any part of the spectrum. For example, early iterations of the Data Over Cable Service Interface Specification (DOCSIS) specified assigned upstream transmissions to a frequency spectrum between 5 MHz and 42 MHz and assigned downstream transmissions to a frequency spectrum between 50 MHz and 750 MHz. Later iterations of the DOCSIS standard expanded the width of the spectrum reserved for each of the upstream and downstream transmission paths, but the spectrum assigned to each respective direction did not overlap. Recently, proposals have emerged by which portions of spectrum may be shared by upstream and downstream transmission, e.g., full duplex and soft duplex architectures.

As the demand for bandwidth invariably increases, it is critical for cable system operators to maintain the highest possible transmission speeds in their deployed plant to provide services in the most efficient way possible. Splitting nodes in a plant and or laying more physical coax or fiber is a costly effort. Minimizing or delaying the amount of physical plant changes is preferable due to the capital costs of doing such.

Plant impairments reduce the overall capacity of the cable plant. Impairments may be due to many factors including damaged coax, improper terminations, or old or underperforming components such as splitters and amplifiers. More recently, the buildout of the wireless infrastructure also contributes to impairments in the cable plant due to the leakage of wireless transmissions into the cable plant. In some cases, the wireless mobile spectrum overlaps with that used by the cable system. When the same frequencies are used in both the mobile and wireless systems, ingress of the wireless signals may into the cable plant may interfere with the signals transmitted within the cable system. Cable systems typically extend up to 1 GHz today while the use of higher frequencies up to 1.8 GHz and potentially higher may be used in the near future. Mobile cellular bands use various frequencies in the 600, 700, 800, and 900 MHz bands for mobile phone services.

In theory, cable plants should be shielded from either emitting spectral energy out of the plant and preventing outside spectral energy (e.g. from mobile cellular bands) into the plant. Practically, plant imperfections and impairments such as those already noted allow for ingress of external spectral energy into the cable plant. External energy that enters into the cable transmission system appears as noise to the on-going transmissions of the cable plant and thus will reduce the capacity of the data transmissions within the cable plant.

What is desired, therefore, are systems and methods that measure the amount of interference into a CATV plant.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates an Orthogonal Frequency Division Multiplexing technique.

FIG. 2 illustrates a Quadrature Amplitude Modulation technique.

FIG. 3 shows exemplary RxMer measurements band returned from a single cable modem .

FIG. 4 shows the “interference band” portion of the measurements of FIG. 3 in which wireless egress could be expected.

FIG. 5 shows a wider view of the measurements of FIG. 4. so as to include adjacent subcarriers.

FIG. 6 shows a scatter plot of interference intensity versus interfere3nce dynamics for RxMER measurements a number of cable modems.

### DETAILED DESCRIPTION

Orthogonal Frequency Division Multiplexing (OFDM) technology was introduced as a cable data transmission modulation technique during the creation of the CableLabs DOCSIS 3.1 specification. DOCSIS (Data Over Cable Service Interface Specification) is a set of standards for the transmission of high speed data services over cable systems. Cable plant services are primarily of two types, digital video programming services and high-speed data services. Digital video programming services have a pre-defined data capacity utilizing lower-order QAM modulation, and these signals are less impacted from ingress of external spectral energy. Conversely, given the ever increasing demand for high speed data services, in both upstream and downstream directions, higher order modulations are required to increase the channel capacity for these services. Increased modulation orders allows for greater bits per hertz of spectrum but also require greater signal to noise environments to operate. Ingress noise may prevent these systems from operating at peak bits per hertz data rates.

DOCSIS 3.1 standard introduced OFDM (Orthogonal Frequency Division Multiplexing) as a method to provide greater transmission bandwidth for high speed data services. OFDM technology was defined for use directly in the downstream direction and was adapted for multiple access (Orthogonal Frequency Division with Multiple Access - OFDMA) for use in the upstream direction. As explained in further detail below, in each direction (upstream/downstream), the relatively wide channel is subdivided into many small subcarriers. Specifically, with OFDM, a data channel may be defined up to 196 MHz for the carriage of data services, and this 196 MHz band is further broken into 50 kHz sub-carriers such that there are up to 3880 sub-carriers within a full 196 MHz OFDM channel. Each of the sub-carriers are effectively an independent transmission channel in that each sub-carrier may utilize its own radio modulation (within the available standards modulations available) depending on the signal to noise ration within its 50 Khz channel. To put into a more familiar perspective, a 50 Khz bandwidth is 5 times the bandwidth available from AM radio today. A single 196 MHz OFDM channel would be able to carry over 15,000 AM radio stations. In the downstream direction, each of these subcarriers may use its own Quadrature Amplitude Modulation (QAM) level, which equates to a different bit capacity per subcarrier QAM symbol. In the upstream direction, groups of subcarriers are combined and, when time multiplexed, create the atomic unit of upstream bandwidth assignment known as a “minislot.” In the upstream direction, all subcarriers of a minislot are assigned the same QAM level and thus all subcarriers of a minislot have the same bit capacity per QAM symbol.

Also as explained in more detail below, OFDM channels in the cable plant are managed by profiles. Because in each of the sub-carriers can use different modulation levels, a profile defines bit loadings vectors to associate with each cable modem, where each vector tells a cable modem what modulation order is used for each particular subcarrier on an upstream or downstream channel. The cable modem then uses the appropriate bitloading vector to demodulate received channels to which it tunes, or to modulate signals it transmits on upstream subcarriers.

As already indicated, the purpose of OFDM/OFDMA technology is to maximize the efficiency of data transmissions across a cable data network by optimizing the QAM modulation level used for each subcarrier of RF frequency bandwidth. Ideally, each cable modem would be assigned its own vector of per-subcarrier QAM modulation levels, i.e. a. bit loading vector, that is uniquely optimized for that cable modem. For cost reasons, however, the DOCSIS 3.1 specification defines a compromise where groups of cable modems having similar RF characteristics can be assigned the same bit loading vector, if that vector is constructed such that that all cable modems assigned that vector could use it. In this manner, the needed number of bit loading vectors is reduced to a cost-manageable set of “bit loading profiles” that could each be assigned to multiple cable modems at once. For example, the current generation of DOCSIS allows head ends that communicate with cable modems to utilize up to sixteen bit loading profiles per channel in the downstream direction and up to seven bit loading profiles per channel in the upstream direction. Similarly, the current generation of DOCSIS permits each cable modem to be assigned up to five profiles per channel in the downstream direction and up to two profiles per channel in the upstream direction.

OFDM is based on the well-known technique of Frequency Division Multiplexing (FDM). In FDM different streams of information are mapped onto separate parallel frequency channels. Each FDM channel is separated from the others by a frequency guard band to reduce interference between adjacent channels.

Orthogonal Frequency Division Multiplexing (OFDM) extends the FDM technique by using multiple subcarriers within each channel. Rather than transmit a high-rate stream of data with a single subcarrier, OFDM makes use of a large number of closely spaced orthogonal subcarriers that are transmitted in parallel. Each subcarrier is modulated with a conventional digital modulation scheme (e.g. QPSK, 16QAM, etc.) at low symbol rate. However, the combination of many subcarriers enables data rates similar to conventional single-carrier modulation schemes within equivalent bandwidths.

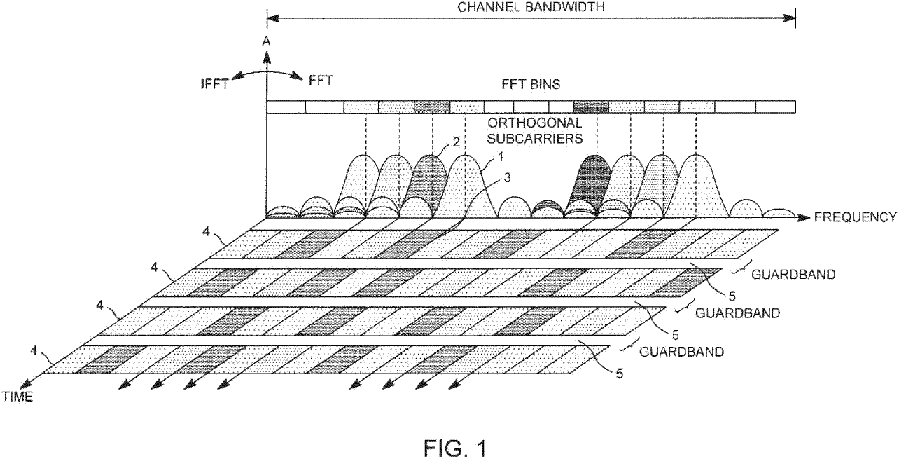

Referring for example to FIG. 1, in the frequency domain, adjacent orthogonal tones or subcarriers 1 and 2 may be each independently modulated with complex data. Though only two subcarriers are illustrated in FIG. 1, those of ordinary skill in the art will appreciate that a typical OFDM transmission will include a large number of orthogonal subcarriers. As just note noted, subcarriers 1 and 2 (as well as all other subcarriers) are orthogonal to each other. Specifically, as can be seen in FIG. 1, subcarrier 1 has spectral energy comprising a sinc function having a center frequency 3 with sidebands having peaks and nulls at regular intervals. These sidebands overlap those of subcarrier 2, but each of the spectral peaks of subcarrier 1 align with the nulls of subcarrier 2. Accordingly, the overlap of spectral energy does not interfere with the system’s ability to recover the original signal; the receiver multiplies (i.e., correlates) the incoming signal by the known set of sinusoids to recover the original set of bits sent.

In the time domain, all frequency subcarriers 1, 2 etc. are combined in respective symbol intervals 4 by performing an Inverse Fast Fourier Transform (IFFT) on the individual subcarriers in the frequency domain. Guard bands 5 may preferably be inserted between each of the symbol intervals 4 to prevent inter-symbol interference caused by multi-path delay spread in the radio channel. In this manner, multiple symbols contained in the respective subcarriers can be concatenated to create a final OFDM burst signal. To recover the signal at a receiver, a Fast Fourier Transform (FFT) may be performed to recover the original data bits.

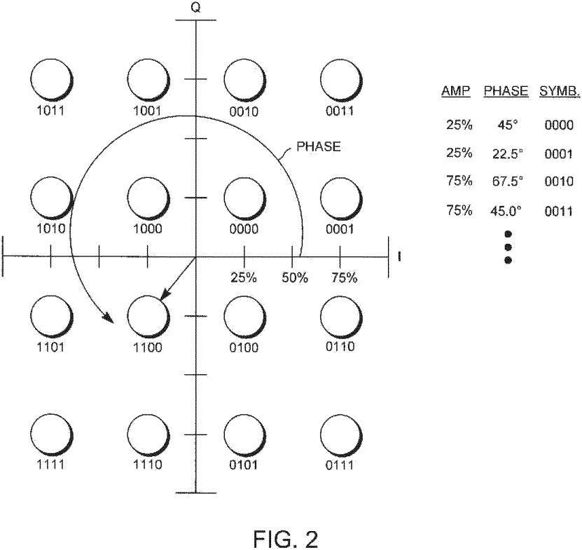

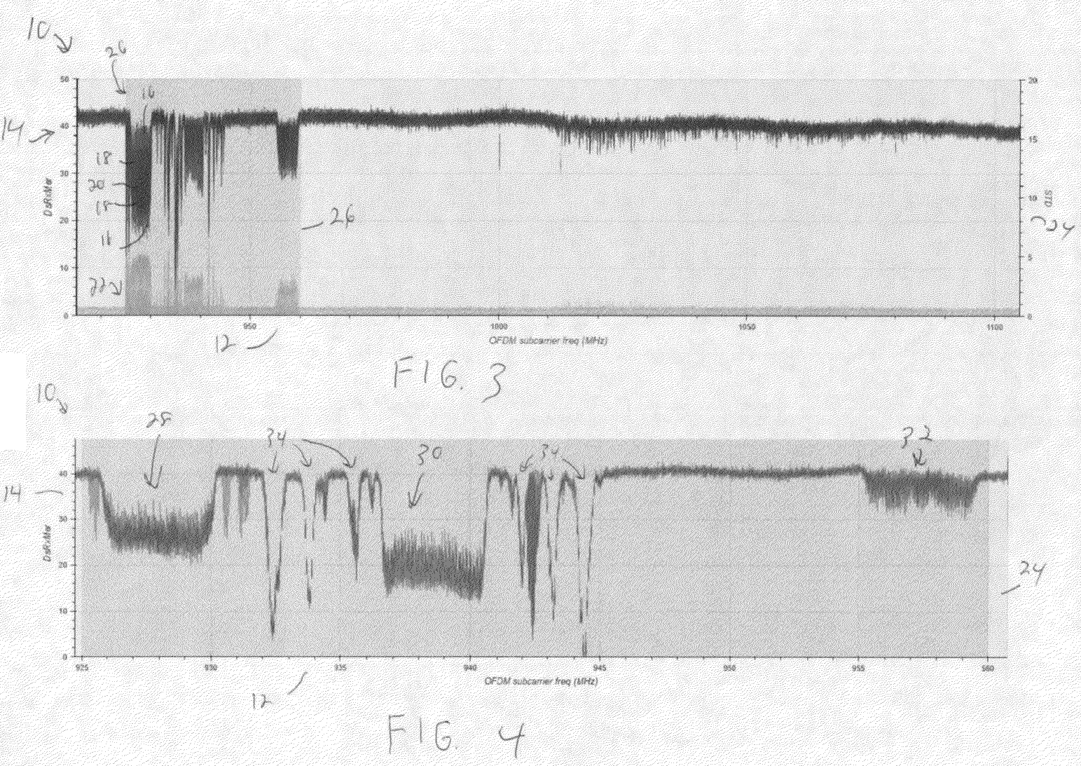

As also noted previously, each subcarrier in an OFDM transmission may be independently modulated with complex data among a plurality of predefined amplitudes and phases. FIG. 2, for example, illustrates a Quadrature Amplitude Modulation (QAM) technique where a subcarrier may be modulated among a selective one of sixteen different phase/amplitude combinations (16QAM). Thus, for example, subcarrier 1 of FIG. 1 may in a first symbol interval transmit the symbol 0000 by having an amplitude of 25% and a phase of 45° and may in a second symbol interval transmit the symbol 1011 by having an amplitude of 75% and a phase of 135°. Similarly, the subcarrier 2 may transmit a selected one of a plurality of different symbols.

FIG. 2 illustrates a 16QAM modulation technique, but modern DOCSIS transmission architectures allow for modulations of up to 16384QAM. Moreover, each of the subcarriers 1, 2, etc. shown in FIG. 1 may operate with its own independent QAM modulation, i.e. subcarrier 1 may transmit a 256QAM symbol while subcarrier 2 may transmit a 2048QAM symbol. Thus, in order for a receiver and a transmitter to properly communicate, a bit loading profile is a vector that specifies, for each subcarrier, the modulation order (16QAM, 256QAM, etc) used by the subcarrier during a symbol interval. The current DOCSIS 3.1 specification allows each cable modem to be assigned up to five different bit loading profiles in the downstream direction, and up to two different bit loading profiles in the upstream direction. The bit loading profile used for a given symbol interval is communicated between the cable modem and a head end, so that transmitted information can be properly decoded.

As already mentioned, ideally each cable modem would be assigned a bit loading profile specifically tailored to the performance characteristics of that cable modem. For example, higher nodulation orders can be assigned to subcarriers experiencing higher a SNR characteristic over a channel used by a cable modem, and lower modulation orders may be best for subcarriers with a low SNR characteristic. In this manner, the bandwidth efficiency of transmissions to and from a cable modem are high when if the cable modem’s ideal bit loading vector closely follows the bit loading profile in use by the cable modem. However, because the DOCSIS standard restricts the number of available profiles that can be used by cable modems, a Cable Modem Termination Service (CMTS) must communicate with multiple cable modems with different SNR profiles using the same bit loading profile. This virtually guarantees that not all cable modems will use a bit loading profile that closely follows its optimum bit loading vector.

Thus, in order to most efficiently use the limited number of available bit loading profiles, the CMTS preferably divides cable modems into groups that each have similar performance characteristics. To this end, the CMTS may periodically include in the downstream transmission known pilot tones that together span the entire OFDM downstream bandwidth. Each cable modem then uses these pilots to measure its error for received downstream transmissions at each subcarrier frequency, where the error at a particular modulation frequency is measured based on the vector in the I-Q plane (shown in FIG. 2) between the ideal constellation point at that modulation order and the actual constellation point received by the receiver. Such error measurements may comprise any of several available forms, including the actual error vector, the Euclidian distance between these two points, or the receiver’s Modulation Error Ratio (MER) or alternately (RxMER), calculated from the error vector. Alternatively, in some embodiments, the error measurement may be expressed as a maximum QAM value that a cable modem may reliably use at a given subcarrier, given the measured error. For example, the DOCSIS 3.1 PHY specification contains tables that map modulations orders to the minimum carrier-to-noise ratios (approximated by MER) required to carry them, as shown in the following exemplary table in the downstream direction:

| Constellation | CNR (1 GHz) | CNR(1.2 GHz) |
|---|---|---|
| 4096 | 41 | 41.5 |
| 2048 | 37 | 37.5 |
| 1024 | 34 | 34.00 |
| 512 | 30.5 | 30.5 |
| 256 | 27 | 27 |
| 128 | 24 | 24 |
| 64 | 21 | 21 |
| 16 | 15 | 15 |

In this exemplary table, “CNR” or Carrier Noise Ratio is defined as the total signal power in an occupied bandwidth divided by the total noise in that occupied bandwidth, and ideally is the equivalent of equalized MER.

The collection of the errors for a cable modem, across all subcarrier frequencies, produces the modulation error vector for that cable modem, which is transmitted back to the CMTS. For upstream transmissions, the process is generally reversed; the CMTS commands each cable modem to send known pilot tones to the CMTS together spanning the entire OFDM upstream bandwidth in a single upstream probing signal for each particular cable modem. The CMTS uses these received probing signals to estimate the upstream modulation error vectors for each of the cable modems.

Once the CMTS has assembled the modulation error vectors for all cable modems that it serves, it uses these vectors to organize the cable modems into “N” groups of cable modems, where “N” is at most the number of profiles available to the collection of cable modems. For example, in a DOCSIS 3.1 environment, cable modems could be arranged in up to sixteen groups for receiving signals in the downstream direction and up to seven groups for receiving signals in the upstream direction.

As just noted, as signal quality increase (e.g., RxMER value increases), higher order modulations can be used in the sub-carrier resulting in more bits/Hz of information capacity for the subcarrier. Though the principal use of RxMER is to determine the appropriate modulation rates for a sub-carrier in the OFDM channel, RxMer can also be used to determine the characteristics of external noise ingress into the cable system from other sources and or other physical plant abnormalities. One such use case is to determine the presence of interference from wireless mobile services utilizing the same frequency bands as the cable system. Understanding the presence and degree of impact of wireless mobile interference is useful to aid in the identification and location of physical plant abnormalities as it is the physical plant abnormalities that allow the ingress of the wireless signals into the plant.

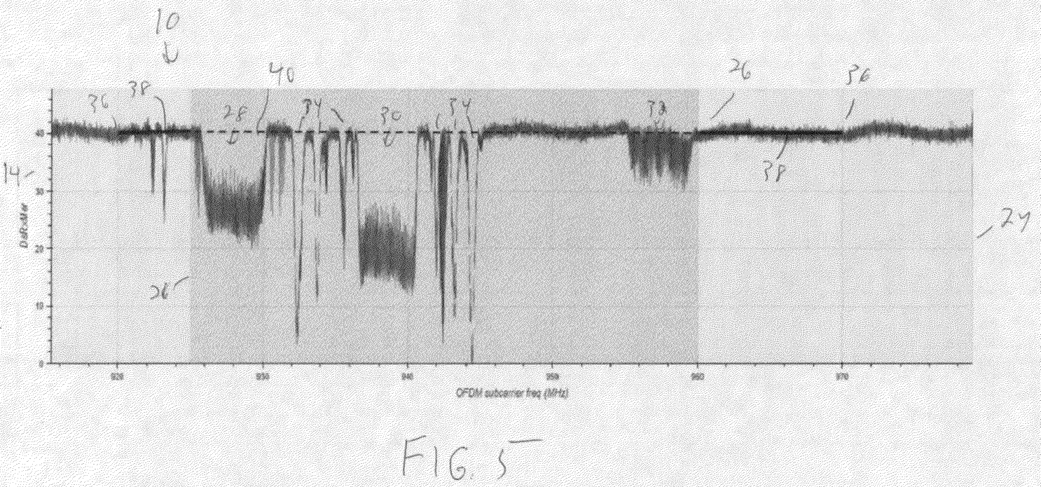

FIG. 3 shows exemplary RxMER measurements 10 returned from a single cable modem over several different reporting periods. Those of ordinary skill in the art will appreciate that, although a cable modem is used as an example to demonstrate equipment into which RF noise may intrude, other equipment in a CATV plant may also be affected by RF noise, such as nodes, amplifiers, taps, etc. which may, for example, be in the vicinity of wireless cell towers, base stations, etc. - particularly given that CATV networks are increasingly being used for wireless backhaul to deliver local wireless signals to and from the Internet. Similarly, though this specification will use RxMER measurements to characterize ingress noise in a cable modem or other device, those of ordinary skill in the art will recognize that the disclosed systems and methods may be used with other metrics such as CNR, SNR, etc.

In FIG. 3, the x-axis shows the frequency spectrum 12 over which measurements are taken, which in this example was over the range from 915 MHz to just over 1100 MHz, while the y-axis provides readings 14 of RxMER. The RxMER readings 14 are preferably provided from the cable modem for every sub-carrier of 50 kHz. FIG. 3 includes has 3880 values of RxMER spread across the 915-1110 MHz span and combines readings from approximately thirty different reporting periods for the same modem, and therefore there are thirty points per sub-carrier. FIG. 3 also includes shadings that distinguish between the min and max readings 16 for each sub-carrier set of measurements, the 90% to 10% readings 18, and the 40% to 60% readings 20). The lower curve 22 represents the standard deviation of the readings for each set of sub-carrier values with the y-axis scale 24 for the standard deviation values on the right side of the chart. The mobile interference band is well known, as these are frequency bands are typically regulated by government include spectral power and channelization within the band. Thus, the shaded area 26 of the chart shows the potential spectral overlap region with mobile wireless services from 925 MHz to 960 MHz. The impact of the ingress from these services is apparent from seeing the drop in RxMER values for individual sub-carriers within the 925-960 MHz region. Note that not all of the sub-carriers inside the mobile frequency band show the presence of interference, because not all of the wireless channels within that band necessarily operate all the time.

While the presence of mobile interference is apparent from looking at the plotted OFDM RxMER data, automated methods to detect, quantify, and otherwise characterize the relative degree of wireless interference on a cable modem would be helpful in locating and prioritizing those portions of the network that may be most impacted by the interference.

The cable plant includes various splitters and amplifiers between the coaxial transmitter, such as that within a node, and the cable modem receiver so that there is not a well-known expected RxMER level that may be uses as a reference. The RxMER at any cable modem may range from ten or twenty decibels for modems with poor reception to forty or forty five decibels for modems with strong reception. Also, as is apparent from FIG. 3, not all sub-carriers within the interference band may be impacted. Some modems may see all sub-carriers impacted within the interference band while others may only see a subset of sub-carriers impacted and the RxMER degradation for each sub-carrier may be vastly different for each cable modem. How to quantify the degree of mobile interference for each device is not obvious given all these variations. Disclosed are systems and methods that not only quantify the level of mobile interference within the band for each cable modem, but also quantify how dynamic that mobile interference band is, i.e. are the mobile interference bands always present at the same level, or does the level change over time. In some preferred embodiments, these two metrics can be combined to characterize the interference to which a cable modem or other piece of equipment in a CATV network is subjected.

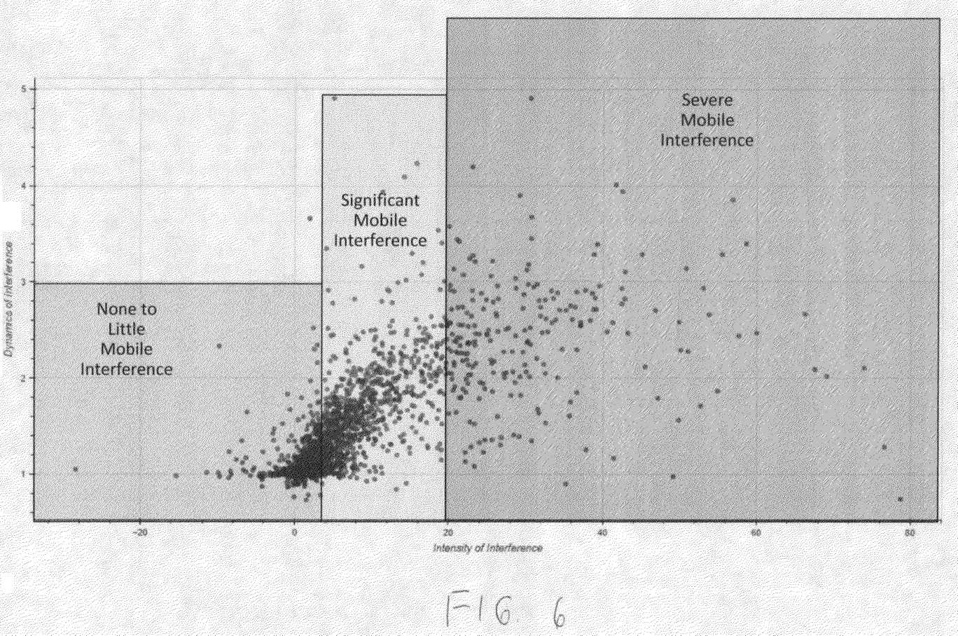

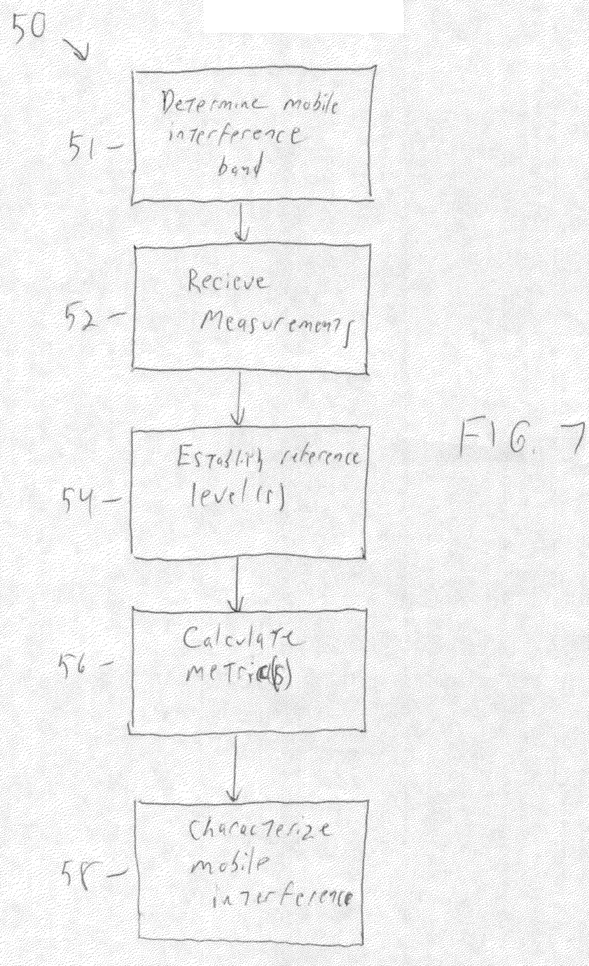

FIG. 4 shows the interference band of the measurements shown in FIG. 3. The sub-carriers between 926-930 MHz show a level of interference as do the subcarriers 30 and 32 between 937-941 MHz and 956-959 MHz, respectively, each with different levels of interference. Also, there are narrow notches 34 around 932, 934, 936, 942, 943, 944 MHz showing interference. FIG. 5 shows a slightly wider view of the OFDM channel, including adjacent sub-carriers 36 on each side of the mobile interference channel.

To calculate an interference level metric, the disclosed systems and methods employs a statistical technique to determine the level of RxMER just outside the interference band, using the adjacent subcarriers 36. These frequencies nearest, but outside of the interference band, are preferred as they provide a good indicator of the expected level of RxMER in the frequency band of interest. Other frequency ranges could also be used; however, in some situations impairments such as RF roll-off at higher frequencies may negatively impact the expected level of RxMER in the interference band of interest. In FIG. 5, the solid black lines 38 indicate the mean value of the readings for the sub-carriers in the vicinity of the interference band. In this example, the 5 Mhz band preceding the interference band and the 20 Mhz band following the interference band are used to calculate the median value. Projecting this level into the interference band provides a reference level to be used in assuming the case of no mobile interference. This is projection is depicted by the dashed line 40 in FIG. 5.

With a reference level established, the next step is to calculate the area under the reference level within the interference band and the actual RxMER readings from the cable modem. Mathematically this is equivalent to integrating the area between the reference line and the actual readings within the interference bands. In a preferred embodiment, this area may be explicitly calculated by summing for each sub-carrier in the interference band the value of the reference level minus the actual sub-carrier reading.

$$M I = {\sum }_{s c} D {B}_{r f} - D {B}_{s c}$$

By summing the value of reference level minus the sub-carrier RxMER reading, on a sub-carrier by sub-carrier basis, a single metric is obtained representing the degree of interference for a particular modem or other piece of equipment. A linear scale value could also be used, if desired, to scale the MI sum to a range different than that determined from the actual calculations. Using a single MI metric calculated for each cable modem in a service group, or within the entire CMTS or operator footprint permits comparisons and rankings of e.g., modems that exhibiting more or less interference relative to each other within the mobile interference band. If multiple interference bands are present within the OFDM channel, a metric may be calculated for each interference band allowing for comparison of modems by interference band or by total sum of interference including all interference bands.

Determining a metric for the magnitude of interference is useful for ranking individual modems and or larger collections of modems (e.g. service groups) to determine where to focus resources to reduce or eliminate the interference. Determining the dynamics associated with the mobile interference can also be useful to establish guidelines on how to manage the channel profiles to maximize the transmission throughput given the mobile interference. In some cases, the mobile interference in a particular sub-carrier may be static while in other cases, the mobile-interference may change frequently. In FIGS. 4 and 5, the sub-carrier dynamics (measured level changes over time) are apparent by the thick bands for most of the impaired sub-carriers inside the interference band. The difference between the maximum reading and minimum reading may be 15 dB or more.

To calculate a single metric for the dynamics associated with an interference band, a reference level may be calculated similar to the case of the mobile intensity (MI) level metric. In this case, the reference value may be calculated by taking the average of the standard deviations (FIG. 3) calculated on a sub-carrier by sub-carrier basis across the sub-carriers in the vicinity, but outside of the interference band. These can be the same reference bands as used in the MI calculation. The second step is to calculate the average standard deviation on a sub-carrier by sub-carrier basis for all sub-carriers within the interference band. Finally, the interference band sub-carrier average standard deviation value may be normalized by dividing this value by the standard deviation reference value calculated from the adjacent sub-carriers. By normalizing to the reference value this removes the general variance seen on the channel, and results in only the variance associated with the mobile interference. As in the case of the mobile intensity metric, the mobile dynamic metric may be linearly scaled to result in any desired range.

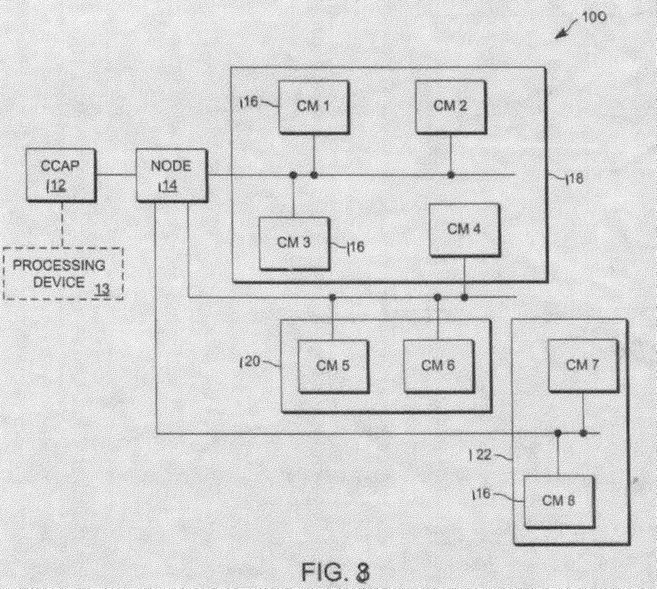

In some embodiments, it may be preferable to combine the interference intensity or magnitude metric, and the interference dynamics metric into a single performance characterization of the interference to which a cable modem or other piece of equipment is subjected. FIG. 6, for example, shows an interference scatter plot plotting the interference intensity for cable modems on the x-axis and the interference dynamic metric on the y-axis. The data in FIG. 6 represents measurements collected from 3200 devices (cable modems) in numerous service groups with up to 72 random readings per device. The data did not appear to be correlated with service groups, but likely did correlate with proximity to mobile base stations.

Also as shown in FIG. 6, the interference level of a cable modem may be characterized by the data represented in the figure. In some preferred embodiments, both metrics may be used in the characterization, for example, cable modems demonstrating interference intensity below about 5 dB and interference dynamics less than 3 may be characterized as demonstrating little mobile interference. Those cable modems demonstrating interference intensity between about 5 dB and 20 db, or interference dynamics between 3 and 5 may be characterized as demonstrating significant mobile interference (including e.g., the single data point at about {3 dB, 3}. Those cable modems demonstrating interference intensity greater than 20 db, or interference dynamics greater than 5 may be characterized as demonstrating significant severe mobile interference. Those of ordinary skill in the art will appreciate that these thresholds are exemplary, as other thresholds may be used. Moreover, in some embodiments, only one metric may be used to characterize mobile interference for a device. For example, characterization of interference may be based only on comparing interference intensity to a threshold, while interference dynamics are used for other purposes. Similarly, the interference intensity values may also be used for additional analysis besides just a characterization of the amount of mobile interference. For example, intensity interference values less than zero may indicate other spectral conditions/anomalies.

FIG. 7 shows an exemplary method 40 according to the foregoing disclosure. At step 51 the mobile interference band is determined. In a preferred embodiment, the mobile interference band extends between 925 MHz to 960 MHz, but those of ordinary skill in the art will appreciate that other boundaries may be selected, particularly if spectrum used for wireless communications expands or moves. Those of ordinary skill in the art will also understand that, in some embodiments the mobile interference band is predetermined, e.g. the mobile interference band may be determined from values stored in memory of a processing device used to perform the method.

At step 53 noise measurements are received from network devices such as cable modems, node, amplifiers, etc., which reflect the intensity of noise in a In some embodiments, these measurements may be RxMER measurements, but other embodiments may use other metrics such as CNR, SNR, etc. At step 54, one or more reference levels for metrics are calculated, which in preferred embodiments are calculated using the measurements taken in step 52 that are outside the interference band determined in step 51.

At step 56 one or more metrics are calculated using the reference levels(s) of step 54. In a preferred embodiment, one metric representing the noise experienced by a cable modem may be an interference intensity metric calculated by, for each subcarrier, subtracting the measured noise level(s) in the subcarrier from the reference level, and then summing the differences over all subcarriers in the interference band. In some embodiments, one metric may be an interference dynamics measurement that determines the amount by which noise levels vary within a subcarrier. This metric may be calculated by measuring, for each cable modem or other piece of equipment, a standard deviation of noise over time for both the interference band and a selected area adjacent the reference band (which establishes a reference level as described above). Then, the standard deviations in the interference band are averaged to arrive at a single average value, which in some embodiments may also be optionally normalized by dividing that average by the reference standard deviation.

At step 58 one or more of the metrics of step 56 are used to characterize the mobile interference in each cable modem or other piece of equipment as previously described.

FIG. 8 shows an exemplary system that may be used to automatically perform the methods disclosed in this specification. This figure illustrates a system that uses QAM-modulated OFDM/OFDMA channels to communicate data in a DOCSIS architecture. Specifically, a system 110 may include a Converged Cable Access Platform (CCAP) 112 typically found within a head end of a video content and/or data service provider. Those of ordinary skill in the art will recognize that the disclosed systems and methods may be used with a Cable Modem Termination Service (CMTS) instead of a CCAP, or other centralized devices of a content provider that act as a source to provide downstream data to, and receive upstream data from, a cable modem through an intervening distribution network. Collectively, such centralized devices may be referred to as a “head end device.” The CCAP 112 communicates with a plurality of cable modems 116 at its customers’ premises via a network through one or more nodes 114. Typically, the network may be a hybrid fiber-coaxial network where the majority of the transmission distance comprises optical fiber, except for trunk lines to cable taps (not shown) at the customers’ premises and cabling from the taps to the cable modems 16, which are coaxial. Preferably, the system 110 includes at least one processor 13 that is operatively connected to memory and performs any or all of the method steps previously described.

The cable modems and/or nodes may preferably include spectrum analyzers or other similar devices capable of measuring noise levels in the OFDM subcarriers they receive. In some embodiments, these noise levels are measured in response to tones or other signals sent from the CMTS/node etc. In some embodiments, the noise measurements (e.g., RxMER) is sent upstream to the processing device 113 for analysis according to the methods previously described. IN other embodiments, some or all of this functionality may be performed by a similar processing device in the cable modems 116 (or nodes 120), and the results sent back to the CMTS/CCAP 112.

In some embodiments, the processing device may use the calculated metrics or characterizations - e.g., the interference intensity metric, the interference dynamic measurement, or a quality characteristic based on comparing one or more of these metrics to respective thresholds - to automatically adjust the system 110. For example, the processor 110 may use the collected metrics/characterization to modify the bit loading profiles of the system by changing the modulation level of one or more subcarriers. Alternatively, the processor 112 may distribute the bit loading profiles differently among the cable modems, reorganize the cable modems into different interference groups, or otherwise assign bit loading profiles to cable modems based on the calculated metrics/characterizations.

Those of ordinary skill in the art will also recognize that other architectures may also be employed, such as distributed access architectures in which some or all of the functionality of the CMTS is moved to the nodes (114).

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein. In the event of inconsistent usages between this document and those documents so incorporated by reference, the usage in the incorporated reference(s) should be considered supplementary to that of this document; for irreconcilable inconsistencies, the usage in this document controls. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. An apparatus in a communications network propagating radio frequency (RF) communications comprising a plurality of subcarriers, the device comprising a processor configured to receive noise measurements associated with a network device for each of the plurality of subcarriers, and use the noise measurements to characterize the severity of noise ingress into the network device specifically due to interference from wireless communications in proximity to the network device.

2. The apparatus of claim 1 comprising the network device.

3. The apparatus of claim 1 where the processor characterizes the severity of noise ingress into the network device specifically due to interference from wireless communications based upon separating the plurality of subcarriers into a first group of subcarriers and a second group of subcarriers.

4. The apparatus of claim 3 where the processor characterizes the severity of noise ingress into the network device specifically due to interference from wireless communications based upon a comparison of noise measurements in the first group of subcarriers to noise measurements in the second group of subcarriers.

5. The apparatus of claim 1 where the characterization comprises a metric representing a magnitude of interference from wireless communications.

6. The apparatus of claim 1 where the characterization comprises a metric representing the dynamics of interference from wireless communications.

7. The apparatus of claim 6 where the metric representing the dynamics of interference from wireless communications is based on a standard deviation of noise measurements within a first range of subcarriers in the signal.

8. The apparatus of claim 6 where the metric representing the dynamics of interference from wireless communications is an average of respective standard deviations of noise measurements within a first range of subcarriers in the signal.

9. The apparatus of claim 8 where the average is normalized using a noise measurements from outside the first range of subcarriers.

10. The apparatus of claim 1 where the processor uses the characterization of the severity of noise ingress into the network device specifically due to interference from wireless communications to perform at least one of a configuration of the network device or a configuration of at least one of a signal sent to the network device.

11. A method performed by a processor in a communications network propagating radio frequency (RF) communications comprising a plurality of subcarriers, the method comprising:
receiving noise measurements from a network device for each of the plurality of subcarriers; and
using the noise measurements to characterize the severity of noise ingress into the network device specifically due to interference from wireless communications in proximity to the network device.

12. The method of claim 11 where the processor is in the network device.

13. The method of claim 11 where the processor characterizes the severity of noise ingress into the network device specifically due to interference from wireless communications based upon separating the plurality of subcarriers into a first group of subcarriers and a second group of subcarriers.

14. The method of claim 13 where the processor characterizes the severity of noise ingress into the network device specifically due to interference from wireless communications based upon a comparison of noise measurements in the first group of subcarriers to noise measurements in the second group of subcarriers.

15. The method of claim 11 where the characterization comprises a metric representing a magnitude of interference from wireless communications.

16. The method of claim 11 where the characterization comprises a metric representing the dynamics of interference from wireless communications.

17. The method of claim 16 where the metric representing the dynamics of interference from wireless communications is based on a standard deviation of noise measurements within a first range of subcarriers in the signal.

18. The method of claim 16 where the metric representing the dynamics of interference from wireless communications is an average of respective standard deviations of noise measurements within a first range of subcarriers in the signal.

19. The method of claim 8 where the average is normalized using a noise measurements from outside the first range of subcarriers.

20. The method of claim 11 where the processor uses the characterization of the severity of noise ingress into the network device specifically due to interference from wireless communications to perform at least one of a configuration of the network device or a configuration of at least one of a signal sent to the network device.
